(19) United States
(12) Patent Application Publication
(10) Pub. No.: US 2016/0353175 A1
(43) Pub. Date: Dec. 1, 2016

(54) METHOD AND APPARATUS FOR SELECTING CAROUSEL PROGRAM ON SMART TV

(71) Applicant: LE SHI ZHI XIN ELECTRONIC TECHNOLOGY (TIANJIN) LIMITED, Beijing (CN)

(72) Inventors: Jiazi TIAN, Beijing (CN); Haibo TANG, Beijing (CN); Yonghui TONG, Beijing (CN)

(21) Appl. No.: 15/039,030

(22) PCT Filed: Nov. 12, 2014
(86) PCT No.: PCT/CN2014/090902

§ 371 Date: May 24, 2016

(30) Foreign Application Priority Data
Nov. 25, 2013 (CN) 201310608787.5

(51) Int. Cl. H04N 21/482; H04N 21/643; H04N 21/2187; H04N 21/433; H04N 21/238; H04N 21/472; H04N 21/64

(52) U.S. Cl. CPC H04N 21/482; H04N 21/47202; H04N 21/64322; H04N 21/64; H04N 21/4334; H04N 21/238; H04N 21/2187; H04N 21/47217

(57) ABSTRACT

A method includes: acquiring a program list of a current carousel channel from a server, and displaying the program list in a playing image of the current carousel channel, wherein a program list of each carousel channel is saved in the server; switching, in response to a selection operation to a program in the program list of the current carousel channel, a channel from the current carousel channel to an on-demand channel; and acquiring on-demand programs of the program selected, and displaying information of the on-demand programs in an interface of the on-demand channel. In this way, when a user selects any program in a program list, a television may switch from a carousel channel which can be watched only in a passive manner to an on-demand channel that allows active selection. Moreover, an effect of increasing flexibility for program watching is achieved, and user experience is improved.

### FIELD OF TECHNOLOGY

The present application relates to the field of smart TVs, and in particular to a method and an apparatus for selecting a carousel program on a smart TV.

### BACKGROUND

With the improvement of people's living standard, smart TVs are increasingly popularized in families with an increasingly strong trend of taking the place of traditional TVs, and thus play an increasingly important role in daily leisure and entertainment lives of people.

At present, smart TVs can play more and more types of programs, including traditional signal source live TV programs, network channel programs and the like, wherein a user can watch network on-demand programs through networking selection on a smart TV or watch programs of a network live broadcast channel on line (‘network live broadcast channel’ is also called ‘carousel channel’). Hence, the user has more and more options on TV programs to be watched.

However, in the process of implementing the present disclosure, the inventor of the present application finds out at least the following problem in the prior art: when a user is watching a program of a carousel channel, the user cannot watch a program played before the program playing at present in the carousel channel and also cannot skip the program playing at present to directly watch a later program, leading to that the user only can watch the program playing at present in the carousel channel passively according to a program list arrangement of the carousel channel; that is to say, the user only can watch a program playing at present in the carousel channel. This will certainly cause a bad experience of the user.

### SUMMARY

One purpose of a method and an apparatus for selecting a carousel program on a smart TV is to solve the following problem: a user does not need to watch a program playing at present passively according to a program list of a carousel channel and can catch up programs played before and skip to programs about to play later, such that the flexibility for program watching is increased and the experience of the user is enhanced.

Based on the purpose, embodiments of the present application provide the following technical solutions:

A method for selecting a carousel program on a smart TV includes:

acquiring a program list of a current carousel channel from a server, and displaying the program list of the current carousel channel in a playing image of the current carousel channel, wherein a program list of each carousel channel is saved in the server;

switching, in response to a selection operation to a program in the program list of the current carousel channel, a channel from the current carousel channel to an on-demand channel; and

acquiring, from the server, on-demand programs of the program selected by the selection operation, and displaying information of the on-demand programs in an interface of the on-demand channel.

Preferably, the acquiring, from the server, the on-demand programs of the program selected by the selection operation includes:

determining a name of the program selected by the selection operation and taking the same as a target program name; and

searching from the server for programs having the target program name as the on-demand programs of the program selected by the selection operation.

Preferably, the method further includes:

searching from the server for associated programs of the on-demand programs, putting information of the associated programs found out in the same list to form an on-demand program list, and displaying the on-demand program list in an interface of the on-demand channel.

Preferably, the method further includes:

extracting link addresses of the associated programs found out in the server before putting the information of the associated programs found out in the same list;

wherein the putting the information of the associated programs found out in the same list specifically is:

putting the information and the link addresses of the associated programs found out in the same list after a corresponding relation therebetween is established.

Preferably, the method further includes:

taking, in response to an address selection operation to a link address in the on-demand program list, video data of a program corresponding to the link address selected by the address selection operation from the server, and playing the video data in the on-demand channel.

The embodiments of the present application further provide an apparatus for selecting a carousel program on a smart TV, including:

a carousel module configured to acquire a program list of a current carousel channel from a server, and display the program list of the current carousel channel in a playing image of the current carousel channel, wherein a program list of each carousel channel is saved in the server;

a switching module configured to switch, in response to a selection operation to a program in the program list of the current carousel channel, a channel from the current carousel channel to an on-demand channel; and

a selection module configured to acquire, from the server, on-demand programs of the program selected by the selection operation, and display information of the on-demand programs in an interface of the on-demand channel.

Preferably, the selection module includes:

a determination module configured to determine a name of the program selected by the selection operation and take the same as a target program name; and

a searching module configured to search from the server for programs having the target program name as the on-demand programs of the program selected by the selection operation.

Preferably, the apparatus further includes:

a list module configured to search from the server for associated programs of the on-demand programs, put information of the associated programs found out in the same list to form an on-demand program list, and display the on-demand program list in the interface of the on-demand channel.

Preferably, the list module further includes:

an extraction module configured to extract link addresses of the associated programs found out in the server before putting the information of the associated programs found out in the same list;

a list module configured to put the information and the link addresses of the associated programs found out in the same list after a corresponding relation therebetween is established;

wherein the list module is specifically configured to:

search from the server for the associated programs of the on-demand programs, extract the link addresses of the associated programs found out in the server, put the information and the link addresses of the associated programs found out in the same list after a corresponding relation therebetween is established to form the on-demand program list, and display the on-demand program list in the interface of the on-demand channel.

Preferably, the apparatus further includes:

a taking module configured to take, in response to an address selection operation to a link address in the on-demand program list, video data of a program corresponding to the link address selected by the address selection operation from the server, and play the video data in the on-demand channel.

The embodiments of the present application further provide a computer-readable recording medium on which a program for executing the method is recorded.

By utilizing the technical solutions, the method and the apparatus for selecting the carousel program on the smart TV provided by the embodiments of the present application allow a user to catch up programs played before and skip to programs about to play later without necessarily watching a program playing at present passively according to a program list of a carousel channel, such that the flexibility for program watching is increased and the experience of the user is improved.

### BRIEF DESCRIPTION OF THE DRAWINGS

In order to describe the technical solutions in the embodiments of the present application more clearly, accompanying drawings needing to be used in descriptions of the embodiments will be described simply below; obviously, the accompanying drawings in the descriptions below are merely some embodiments of the present application, and for those ordinary skilled in the art, other accompanying drawings can be further obtained according to the accompanying drawings without creative labor.

FIG. 1 is a flow schematic diagram of a method for selecting a carousel program on a smart TV provided by an embodiment of the present application;

FIG. 2 is a flow schematic diagram of a method for acquiring, from a server, on-demand programs of a program selected by a selection operation provided by an embodiment of the present application;

FIG. 3 is a flow schematic diagram of another method for selecting a carousel program on a smart TV provided by an embodiment of the present application;

FIG. 4 is a flow schematic diagram of further method for selecting a carousel program on a smart TV provided by an embodiment of the present application;

FIG. 5 is a flow schematic diagram of still further method for selecting a carousel program on a smart TV provided by an embodiment of the present application;

FIG. 6 is a structural schematic diagram of an apparatus for selecting a carousel program on a smart TV provided by an embodiment of the present application;

FIG. 7 is a structural schematic diagram of a selection module provided by an embodiment of the present application;

FIG. 8 is a structural schematic diagram of another apparatus for selecting a carousel program on a smart TV provided by an embodiment of the present application;

FIG. 9 is a structural schematic diagram of further apparatus for selecting a carousel program on a smart TV provided by an embodiment of the present application;

FIG. 10 is a structural schematic diagram of still further apparatus for selecting a carousel program on a smart TV provided by an embodiment of the present application.

### DESCRIPTION OF THE EMBODIMENTS

The technical solutions in the embodiments of the present application will be described clearly and completely below in combination with the accompanying drawings in the embodiments of the present application. Obviously, the described embodiments are merely one part but not all of the embodiments of the present application. Based on the embodiments in the present application, all other embodiments obtained by those ordinary skilled in the art without creative labor are within the scope of protection of the present application.

One of the main ideas of the embodiments of the present application may include: when a user selects any one program in a program list, a television may switch from a carousel channel which can be watched only in a passive manner to an on-demand channel that allows active selection. Moreover, on-demand programs corresponding to a program selected by the user are displayed in the on-demand channel, and in this case, the user may watch the selected program, so that effects of catching up programs played before and skipping to programs about to play later, and increasing flexibility for program watching are achieved, and user experience is enhanced.

The solutions of the present application will be specifically explained below through specific embodiments:

### Embodiment 1

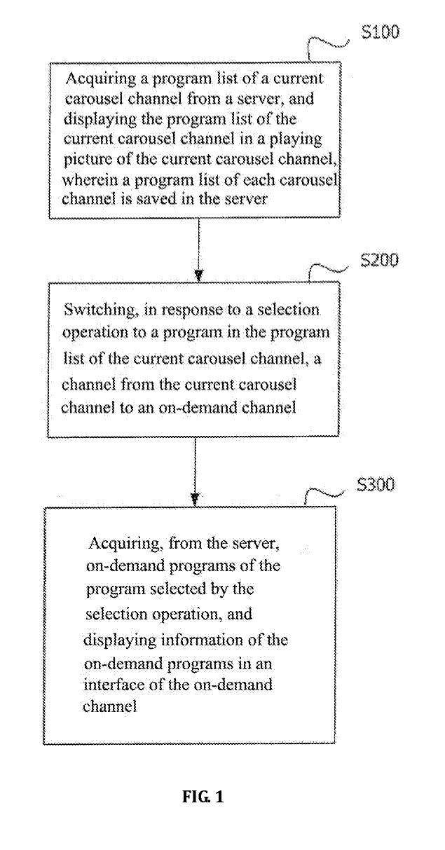

FIG. 1 is a flow schematic diagram of a method for selecting a carousel program on a smart TV provided by an embodiment of the present application.

Referring to FIG. 1, the embodiment of the present application provides a method for selecting a carousel program on a smart TV, including:

S100: acquiring a program list of a current carousel channel from a server, and displaying the program list of the current carousel channel in a playing image of the current carousel channel, wherein a program list of each carousel channel is saved in the server;

In the embodiment of the present application, the server will establish at least one carousel channel and set a program list for each carousel channel, wherein each program list at least includes program names allocated by the server for the corresponding carousel channel and arranged playing time of each program; next, the programs in the corresponding carousel channel are enabled to play in real time according to the program list and a program signal of the carousel channel playing in real time is sent to a client.

After the client identifies a carousel channel that the user is watching at present according to a playing program, the current carousel channel can be taken as a target carousel channel and the program list corresponding to the target carousel channel is searched from the program lists of the carousel channels generated by the server.

Here, the program list of the current carousel channel may include program information such as a program name and playing time of the program playing at present, program names and playing time of programs that have already played in the current carousel channel, and program names and playing time of programs about to play in the current carousel channel.

In the embodiment of the present application, as long as the program list found out of the current carousel channel is loaded in video data of the current carousel channel, the program list of the current carousel channel can be displayed in a video image of the current playing carousel channel so that the user can operate and view the program list.

Here, the program list can be displayed in the video image in the form of a semitransparent list or displayed in a video interface of the playing program in order on a timeline; in this case, each node on the timeline corresponds to one piece of program information that can be displayed in the form of a image plus characters or in the form of a video skim; for the program playing at present, a certain identification can be added such that the program can be differentiated from other programs; for example, the program playing at present is highlighted, etc., which is not redundantly described herein.

Here, to display the program list in the video image of the current carousel channel, it can be that the program list is displayed along a side edge in the video image or a bottom edge or a top edge of the video image, which does not affect the user watching the playing program.

For example, when the program list is set along the bottom edge of the video image of the television in the form of the timeline, the user operates a remote controller to pull the timeline rightwards in the video interface to view the program information played before, and operates the remote controller to pull the timeline leftwards in the video interface to view the program information about to play.

It could be understood that when the user does not need to watch the program list or in order to avoid the program list from affecting the user watching the program of the current carousel channel, the user can select to execute an operation of cancelling the program list, and in this case, the server of the smart TV can stop loading the program list in the video data of the current carousel channel in response to a closing operation of the user to the program list, thereby stopping displaying the program list in the video image of the current carousel channel. Moreover, when the user needs to view the program list, the user can select to execute an operation of launching the program list, and in this case, the server of the smart TV can re-load the program list in the video data of the current carousel channel in response to the launching operation of the user to the program list such that the program list of the current carousel channel is displayed in the video image of the current carousel channel. In this way, the program list can be displayed or hidden according to the requirements of the user, and the humanized experience of the user is further improved.

S200: in response to a selection operation to a program in the program list of the current carousel channel, a channel is switched from the current carousel channel to an on-demand channel.

In the prior art, as the programs of each carousel channel are played according to the playing time arranged by a corresponding program list in a server, when a user is watching a program of a carousel channel, the user cannot watch programs played before the program playing at present in the carousel channel and also cannot skip the program playing at present to directly watch a later program, and therefore, the user can only watch the program playing at present in the carousel channel passively according to a program list arrangement of the carousel channel, i.e., the user can only watch a program playing at present in the carousel channel. This will certainly cause a bad experience of the user.

In the embodiment of the present application, when the user selects a program in the program list of the carousel channel, the user will switch the channel of the smart TV from the current carousel channel to the on-demand channel at first; with respect to that a live broadcast channel can only broadcast programs according to the playing time arranged by the program list provided by the server, the on-demand channel may allow the user to select interested programs for playing anytime, such that the subjectivity of the user is stronger.

S300: on-demand programs of the program selected by the selection operation are acquired from the server, and information of the on-demand programs is displayed in an interface of the on-demand channel.

In the embodiment of the present application, the server will pre-save on-demand programs corresponding to each program in a carousel program list, and each program in the carousel program list and the on-demand program corresponding thereto can be the same program located in different storage positions.

Taking a TV series or a movie as an example, when the user chooses one episode of one TV series in a carousel program list, the television can present the information of the on-demand programs of the episode in the on-demand channel for the user; when the user chooses one movie in the carousel program list, the television can present the information of the on-demand programs of the movie in the on-demand channel for the user.

The information herein may contain one or more of program descriptions, program names, program serial numbers and program link addresses of the one-demand programs; different on-demand programs may correspond to different information; for instance, the information of a TV series may contain program serial numbers, while the information of a movie not always contain the program serial number.

Here, the information of the on-demand programs can be displayed in the interface of the on-demand channel in a semitransparent form or embedded in a webpage of the program and displayed in the on-demand channel in the form of a program topic and description page of the program selected by the user; the information of the on-demand programs can be displayed in the form of images plus characters or in the form of video skims, which is not redundantly described herein.

By employing the technical solution provided by the above embodiment of the present application, the program list of the current carousel channel is acquired from the server and displayed in the playing image of the current carousel channel, wherein the program list of each carousel channel is saved in the server; in response to the selection operation to a program in the program list of the current carousel channel, the channel is switched from the current carousel channel to the on-demand channel; the on-demand programs of the program selected by the selection operation are acquired from the server and the information of the on-demand programs is displayed in the interface of the on-demand channel. In this way, when the user selects any program in the program list, the television may switch, in response to the selection operation of the user, from the carousel channel which can be watched only in a passive manner to the on-demand channel that allows active selection. Moreover, the on-demand programs corresponding to the program selected by the user are displayed in the on-demand channel, and in this case, the user may watch the selected program, so that effects of catching up programs played before and skipping to programs about to play later, and increasing flexibility for program watching are achieved, and user experience is improved.

### Embodiment 2

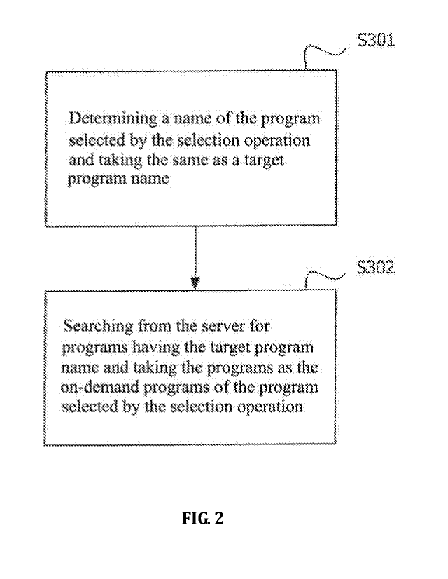

FIG. 2 is a flow schematic diagram of a method for acquiring, from a server, on-demand programs of a program selected by a selection operation provided by an embodiment of the present application.

Please refer to FIG. 2, on the basis of the method provided by embodiment 1, the method provided by the embodiment of the present application specifically includes:

S301: a name of the program selected by the selection operation is determined as a target program name.

In the embodiment of the present application, when a user selects a program in a program list of a carousel channel, a client may determine the program name of the program selected by the user as the target program name according to the program list.

The target program name herein refers to a full name of a program, including a main name, a program serial number, a naming format and the like of the program. Taking a TV series as an example, for example, in a program entitled ‘Legend of Zhenhuan-05’, ‘Legend of Zhenhuan’ herein is the main name of the program; ‘05’ is the program serial number of the program; is the naming format connecting the main name and the program serial number; and the target program name is the full name ‘Legend of Zhenhuan-05’.

S302: programs having the target program name are searched from the server and then taken as the on-demand programs of the program selected by the selection operation.

When the user selects a program in the program list of the current carousel channel, the client searches from the server for programs having the same program name with the program selected by the user as the on-demand programs corresponding to the program selected by the user; moreover, after the on-demand programs corresponding to the program selected by the user are found out, the on-demand programs can be played.

Here, searching from the server for the programs having the target program name refers to searching from the server for the programs the same as the target program name in the main name, the program serial number, the naming format and the like. By taking the above example continuously, when the target program name is ‘Legend of Zhenhuan-05’, searching from the server for the programs having the target program name is to search from the server for the programs having the full name ‘Legend of Zhenhuan-05’.

By employing the technical solution provided by the embodiment of the present application, after the channel is switched from the current carousel channel to the on-demand channel, the on-demand programs having the same name as the program selected by the user are acquired from the server and the information of the on-demand programs is displayed in the interface of the on-demand channel. In this way, when the user selects any program in the program list, the television may switch, in response to the selection operation of the user, from the carousel channel which can be watched only in a passive manner to the on-demand channel that allows active selection. Moreover, the on-demand programs corresponding to the program selected by the user are displayed in the on-demand channel, and in this case, the user may watch the selected program, so that effects of catching up programs played before and skipping to programs about to play later, and increasing flexibility for program watching are achieved, and user experience is improved.

### Embodiment 3

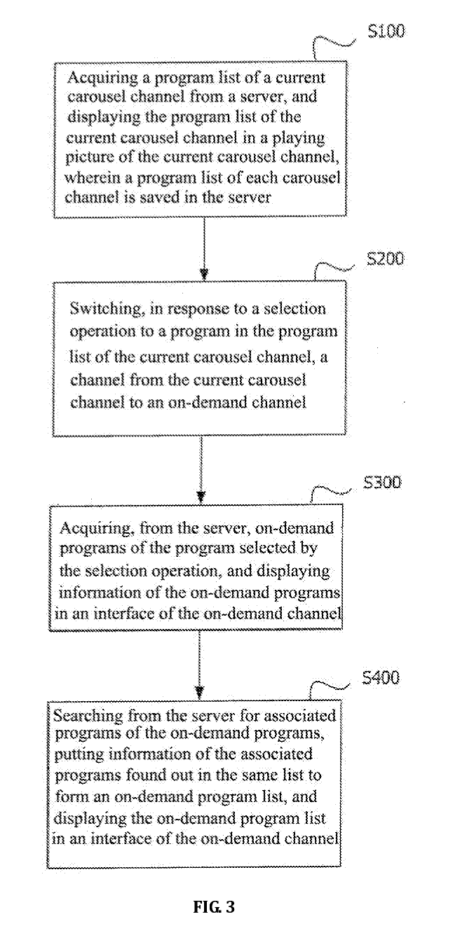

FIG. 3 is a flow schematic diagram of another method for selecting a carousel program on a smart TV provided by an embodiment of the present application.

Please refer to FIG. 3, on the basis of the above embodiment, the method provided by the embodiment of the present application further includes:

S400: associated programs of the on-demand programs are searched from the server, information of the associated programs found out is put in the same list to form an on-demand program list, and the on-demand program list is displayed in an interface of the on-demand channel.

In the embodiment of the present application, the server will pre-save the on-demand programs corresponding to every program in a carousel program list as well as the associated programs of every on-demand program.

Wherein, the associated programs associated with an on-demand program refer to the programs having the same main name but different program serial numbers with the on-demand program. Taking a TV series program as an example, the associated programs can be the previous episode or the next episode of a current episode selected, or the whole episodes of the TV series; taking a movie program as an example, the associated programs can be a first half or a second half of a current movie selected, or the whole series of the movie.

As the associated programs have the same main name with the corresponding on-demand program, they may share the main name of the on-demand program, and therefore, the on-demand program list herein at least contains the program serial numbers of the associated programs associated with the on-demand programs so as to differentiate various programs.

Here, the on-demand program list can be displayed in the interface of the on-demand channel in the form of a semitransparent list or embedded in a program detail page and displayed in the on-demand channel in the form of a program topic and description page of the program selected by the user; the information of the associated programs in the on-demand program list can be displayed in the form of images plus characters or in the form of video skims; for the program selected by the user, a certain identification can be added to the program such that the program can be differentiated from other programs; for example, the program selected by the user is highlighted, etc., which is not redundantly described herein.

Additionally, before the information of the associated programs found out is put in the same list, the information of the associated programs found out also can be sorted according to the program serial numbers of the associated programs found out and then the sorted information of the associated programs found out is put in the same list as the on-demand program list. A sorting mode adopted herein can be forward sorting or reverse sorting according to the order of the program serial numbers so that the program list is clearer and more intuitive and convenient for the user to search and select.

By employing the technical solution provided by the embodiment of the present application, after the channel is switched from a carousel channel to the on-demand channel, a client may acquire, from the server, the associated programs of the on-demand programs corresponding to the program selected by the selection operation; the various associated programs are assigned to the same on-demand program list and the on-demand program list is displayed in the playing image of the on-demand channel, wherein the on-demand program list includes information of programs associated with the program selected by the selection operation, and the information at least includes program serial numbers. In this way, when the user selects any program in the program list, the television may switch, in response to the selection operation of the user, from the carousel channel which can be watched only in a passive manner to the on-demand channel that allows active selection. Moreover, the on-demand program list corresponding to the program selected by the user is displayed in the on-demand channel, and in this case, the user may watch the programs in the on-demand program list, so that effects of catching up programs played before and skipping to programs about to play later, and increasing flexibility for program watching are achieved, and user experience is improved.

### Embodiment 4

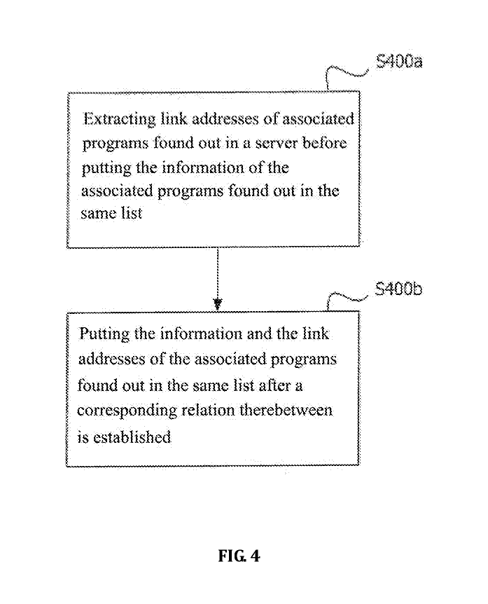

FIG. 4 is a flow schematic diagram of a further method for selecting a carousel program on a smart TV provided by an embodiment of the present application.

Please refer to FIG. 4, on the basis of the above embodiment, the method provided by the embodiment of the present application further includes:

S400a: link addresses of the associated programs found out in the server are extracted before putting the information of the associated programs found out in the same list;

Wherein, the putting the information of the associated programs found out in the same list specifically is:

S400b: the information and the link addresses of the associated programs found out are put in the same list after a corresponding relation therebetween is established.

The link addresses herein can be displayed in the form of images plus characters or video skims or in the form of character descriptions plus link addresses, which is not limited in the embodiment of the present application.

Here, the link addresses of the associated programs found out can be directly extracted from the server after the associated programs are found out; or, after the program main name and the program serial numbers of the associated programs are determined, addresses for saving the various associated programs in the server are searched as the link addresses of the various associated programs.

By employing the technical solution provided by the embodiment of the present application, after the channel is switched from a carousel channel to the on-demand channel, the client may acquire, from the server, the associated programs of the on-demand programs corresponding to the program selected by the selection operation; the various associated programs are assigned to the same on-demand program list and the on-demand program list is displayed in the playing image of the on-demand channel, wherein the on-demand program list includes information of programs associated with the program selected by the selection operation, and the information may include the program serial numbers and the link addresses of the programs. In this way, when the user selects any program in the program list, the television may switch, in response to the selection operation of the user, from the carousel channel which can be watched only in a passive manner to the on-demand channel that allows active selection. Moreover, the on-demand program list corresponding to the program selected by the user is displayed in the on-demand channel, and in this case, the user may watch the programs in the on-demand program list, so that effects of catching up programs played before and skipping to programs about to play later, and increasing flexibility for program watching are achieved, and user experience is improved.

### Embodiment 5

FIG. 5 is a flow schematic diagram of a still further method for selecting a carousel program on a smart TV provided by an embodiment of the present application.

Please refer to FIG. 5, on the basis of embodiment 4, the method provided by the embodiment of the present application may further include:

S500: in response to an address selection operation to a link address in the on-demand program list, video data of a program corresponding to the link address selected by the address selection operation is taken from the server, and the video data is played in the on-demand channel.

It needs to be noted that: if the on-demand program list further includes the link addresses of the associated programs, and when the user is more interested in one program among the associated programs in the on-demand program list, the user can click the link address of the program, and in this case, the smart TV may start to play an associated program corresponding to the link address clicked by the user in response to the address selection operation of the user to the link address of the associated program. In this way, when the user clicks a program in the on-demand program list, namely sending a playing instruction, the client may start to play the associated program selected by the user in response to the playing instruction of the user.

In the embodiment of the present application, the user may not only see the on-demand program list of the selected program in the interface of the on-demand channel, but also directly choose an interested program in the on-demand program list and click the link address corresponding to the program; in this way, the process and time of the user manually searching for a playing address of a recommended associated program according to the information of the associated programs can be omitted, the program watching efficiency of the user is improved and the program watching experience is improved.

### Embodiment 6

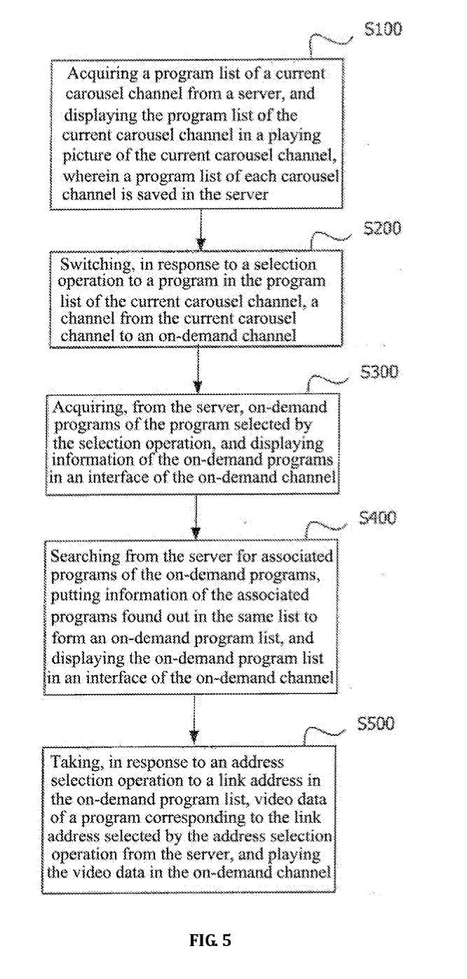

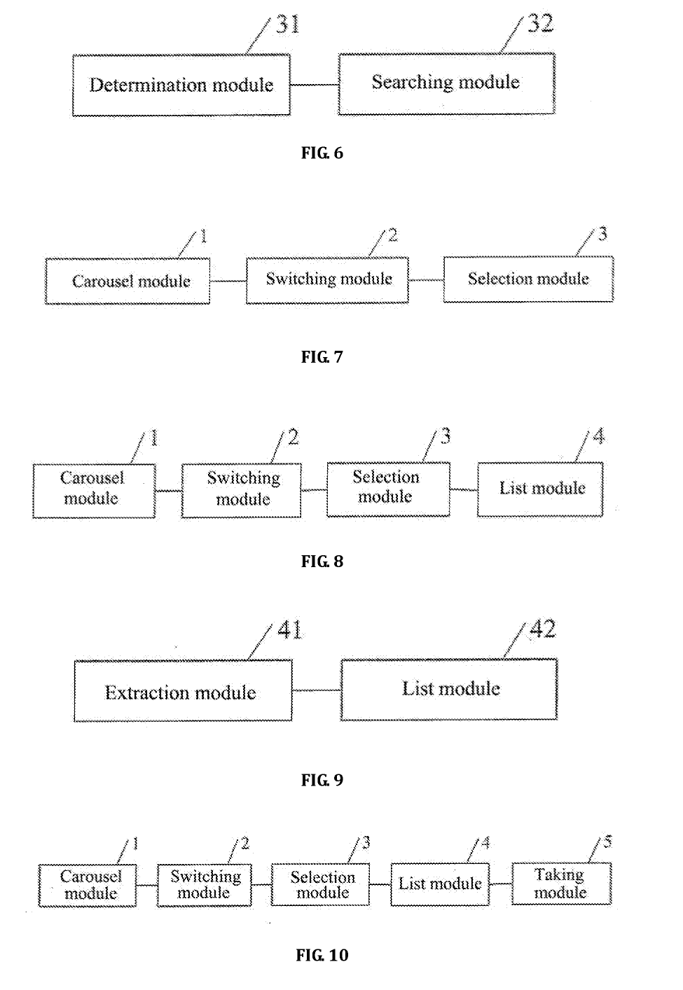

FIG. 6 is a structural schematic diagram of an apparatus for selecting a carousel program on a smart TV provided by an embodiment of the present application.

Please refer to FIG. 6, the apparatus for selecting the carousel program on the smart TV provided by the embodiment of the present application includes:

A carousel module 1, configured to acquire a program list of a current carousel channel from a server, and display the program list of the current carousel channel in a playing image of the current carousel channel, wherein a program list of each carousel channel is saved in the server.

In the embodiment of the present application, the server will establish at least one carousel channel and set a program list for each carousel channel, wherein each program list at least includes program names allocated by the server for the corresponding carousel channel and arranged playing time of each program; next, the programs in the corresponding carousel channel are enabled to play in real time according to the program list and a program signal of the carousel channel playing in real time is sent to a client.

After the client identifies a carousel channel that the user is watching at present according to a playing program, the current carousel channel can be taken as a target carousel channel and the program list corresponding to the target carousel channel is searched from the program lists of the carousel channels generated by the server.

Here, the program list of the current carousel channel may include program information such as a program name and playing time of the program playing at present, program names and playing time of programs that have played in the current carousel channel, and program names and playing time of programs about to play in the current carousel channel.

In the embodiment of the present application, as long as the searched program list of the current carousel channel is loaded in video data of the current carousel channel, the program list of the current carousel channel can be displayed in a video image of the current playing carousel channel so that the user can operate and view the program list.

Here, the program list can be displayed in the video image in the form of a semitransparent list or displayed in a video interface of the playing program in order on a timeline; in this case, each node on the timeline corresponds to one piece of program information that can be displayed in the form of a image plus characters or in the form of a video skim; for the program playing at present, a certain identification can be added such that the program can be differentiated from other programs; for example, the program playing at present is highlighted, etc., which is not redundantly described herein.

Here, to display the program list in the video image of the current carousel channel, it can be that the program list is displayed along a side edge in the video image or a bottom edge or a top edge of the video image, which does not affect the user watching the playing program.

For example, when the program list is set along the bottom edge of the video image of the television in the form of the timeline, the user operates a remote controller to pull the timeline rightwards in the video interface to view the program information played before, and operates the remote controller to pull the timeline leftwards in the video interface to view the program information about to play.

It could be understood that when the user does not need to view the program list or in order to avoid the program list from affecting the user watching the program of the current carousel channel, the user can select to execute an operation of cancelling the program list, and in this case, the server of the smart TV can stop loading the program list in the video data of the current carousel channel in response to a closing operation of the user to the program list, thereby stopping displaying the program list in the video image of the current carousel channel. Moreover, when the user needs to view the program list, the user can select to execute an operation of launching the program list, and in this case, the server of the smart TV can re-load the program list in the video data of the current carousel channel in response to the launching operation of the user to the program list such that the program list of the current carousel channel is displayed in the video image of the current carousel channel. In this way, the program list can be displayed or hidden according to the requirements of the user, and the humanized experience of the user is further improved.

A switching module 2, configured to switch, in response to a selection operation to a program in the program list of the current carousel channel, a channel from the current carousel channel to an on-demand channel.

In the prior art, as the programs of each carousel channel play according to playing time arranged by a corresponding program list in a server, when a user is watching a program of a carousel channel, the user cannot watch programs played before the program playing at present in the carousel channel and also cannot skip the program playing at present to directly watch a later program, and therefore, the user only can watch the program playing at present in the carousel channel passively according to a program list arrangement of the carousel channel, i.e., the user only can watch a program playing at present in the carousel channel. This will certainly cause a bad experience of the user.

In the embodiment of the present application, when the user selects a program in the program list of the carousel channel, the user will switch the channel of the smart TV from the current carousel channel to the on-demand channel; with respect to that a live broadcast channel only can broadcast programs according to the playing time arranged by the program list provided by the server in the live broadcast channel, the on-demand channel may allow the user to select interested programs for playing anytime, such that the subjectivity of the user is stronger.

A selection module 3, configured to acquire, from the server, on-demand programs of the program selected by the selection operation, and display information of the on-demand programs in an interface of the on-demand channel.

In the embodiment of the present application, the server will pre-save on-demand programs corresponding to each program in a carousel program list, and each program in the carousel program list and the on-demand program corresponding thereto can be the same program located in different storage positions.

Taking a TV series or a movie as an example, when the user chooses one episode of one TV series in a carousel program list, the television can present the information of the on-demand programs of the episode in the on-demand channel for the user; when the user chooses one movie in the carousel program list, the television can present the information of the on-demand programs of the movie in the on-demand channel for the user.

The information herein may contain one or more of program descriptions, program names, program serial numbers and program link addresses of the one-demand programs; different on-demand programs may correspond to different information; for instance, the information of a TV series may contain program serial numbers, while the information of a movie not always contain the program serial number.

Here, the information of the on-demand programs can be displayed in the interface of the on-demand channel in a semitransparent form or embedded in a webpage of the program and displayed in the on-demand channel in the form of a program topic and description page of the program selected by the user; the information of the on-demand programs can be displayed in the form of images plus characters or in the form of video skims, which is not redundantly described herein.

By employing the technical solution provided by the above embodiment of the present application, the program list of the current carousel channel is acquired from the server and displayed in the playing image of the current carousel channel, wherein the program list of each carousel channel is saved in the server; in response to the selection operation to a program in the program list of the current carousel channel, the channel is switched from the current carousel channel to the on-demand channel; the on-demand programs of the program selected by the selection operation are acquired from the server and the information of the on-demand programs is displayed in the interface of the on-demand channel. In this way, when the user selects any program in the program list, the television may switch, in response to the selection operation of the user, from the carousel channel which can be watched only in a passive manner to the on-demand channel that allows active selection. Moreover, the on-demand programs corresponding to the program selected by the user are displayed in the on-demand channel, and in this case, the user may watch the selected program, so that effects of catching up programs played before and skipping to programs about to play later, and increasing flexibility for program watching are achieved, and user experience is improved.

### Embodiment 7

FIG. 7 is a structural schematic diagram of a selection module provided by an embodiment of the present application.

Please refer to FIG. 7, on the basis of the method provided by embodiment 6, the apparatus provided by the embodiment of the present application specifically includes:

A determination module 31, configured to determine a name of the program selected by the selection operation and take the same as a target program name.

In the embodiment of the present application, when a user selects a program in a program list of a carousel channel, a client may determine the program name of the program selected by the user as the target program name according to the program list.

The target program name herein refers to a full name of program, including a main name, a program serial number, a naming format and the like of the program. Taking a TV series as an example, for example, in a program entitled ‘Legend of Zhenhuan-05’, ‘Legend of Zhenhuan’ herein is the main name of the program; ‘05’ is the program serial number of the program; is the naming format connecting the main name and the program serial number; and the target program name is the full name ‘Legend of Zhenhuan-05’.

A searching module 32, configured to search from the server for programs having the target program name and take the programs searched as the on-demand programs of the program selected by the selection operation.

When the user selects a program in the program list of the current carousel channel, the client searches from the server for programs having the same program name with the program selected by the user as the on-demand programs corresponding to the program selected by the user; moreover, after the on-demand programs corresponding to the program selected by the user are found out, the on-demand programs can be played.

Here, searching from the server for the programs having the target program name refers to searching from the server for the programs the same as the target program name in the main name, the program serial number, the naming format and the like. By taking the above example continuously, when the target program name is ‘Legend of Zhenhuan-05’, searching from the server for the programs having the target program name is to search from the server for the programs having the full name ‘Legend of Zhenhuan-05’.

By employing the technical solution provided by the embodiment of the present application, after the channel is switched from the current carousel channel to the on-demand channel, the on-demand programs having the same name as the program selected by the user are acquired from the server and the information of the on-demand programs is displayed in the interface of the on-demand channel. In this way, when the user selects any program in the program list, the television may switch, in response to the selection operation of the user, from the carousel channel which can be watched only in a passive manner to the on-demand channel that allows active selection. Moreover, the on-demand programs corresponding to the program selected by the user are displayed in the on-demand channel, and in this case, the user may watch the selected program, so that effects of catching up programs played before and skipping to programs about to play later, and increasing flexibility for program watching are achieved, and user experience is improved.

### Embodiment 8

FIG. 8 is a structural schematic diagram of another apparatus for selecting a carousel program on a smart TV provided by an embodiment of the present application.

Please refer to FIG. 8, on the basis of the above embodiment, the apparatus provided by the embodiment of the present application further includes:

A list module 4, configured to search from the server for associated programs of the on-demand programs, put information of the associated programs found out in the same list to form an on-demand program list, and display the on-demand program list in the interface of the on-demand channel.

In the embodiment of the present application, the server will pre-save the on-demand programs corresponding to every program in a carousel program list as well as the associated programs of every on-demand program.

Wherein, the associated programs associated with an on-demand program refer to the programs having the same main name but different program serial numbers with the on-demand program. Taking a TV series program as an example, the associated programs can be the previous episode or the next episode of a current episode selected, or the whole episodes of the TV series; taking a movie program as an example, the associated programs can be a first half or a second half of a current movie selected, or the whole series of the movie.

As the associated programs have the same main name with the corresponding on-demand program, they may share the main name of the on-demand program, and therefore, the on-demand program list herein at least contains the program serial numbers of the associated programs associated with the on-demand programs so as to differentiate various programs.

Here, the on-demand program list can be displayed in the interface of the on-demand channel in the form of a semitransparent list or embedded in a program detail page and displayed in the on-demand channel in the form of a program topic and description page of the program selected by the user; the information of the associated programs in the on-demand program list can be displayed in the form of images plus characters or in the form of video skims; for the program selected by the user, a certain identification can be added to the program such that the program can be differentiated from other programs; for example, the program selected by the user is highlighted, etc., which is not redundantly described herein.

Additionally, before the information of the associated programs found out is put in the same list, the information of the associated programs found out also can be sorted according to the program serial numbers of the associated programs found out and then the sorted information of the associated programs found out is put in the same list as the on-demand program list. A sorting mode adopted herein can be forward sorting or reverse sorting according to the order of the program serial numbers so that the program list is clearer and more intuitive and convenient for the user to search and select.

By employing the technical solution provided by the embodiment of the present application, after the channel is switched from a carousel channel to the on-demand channel, a client may acquire, from the server, the associated programs of the on-demand programs corresponding to the program selected by the selection operation; the various associated programs are assigned to the same on-demand program list and the on-demand program list is displayed in the playing image of the on-demand channel, wherein the on-demand program list includes information of programs associated with the program selected by the selection operation, and the information at least includes program serial numbers. In this way, when the user selects any program in the program list, the television may switch, in response to the selection operation of the user, from the carousel channel which can be watched only in a passive manner to the on-demand channel that allows active selection. Moreover, the on-demand program list corresponding to the program selected by the user is displayed in the on-demand channel, and in this case, the user may watch the programs in the on-demand program list, so that effects of catching up programs played before and skipping to programs about to play later, and increasing flexibility for program watching are achieved, and user experience is improved.

### Embodiment 9

FIG. 9 is a structural schematic diagram of a further apparatus for selecting a carousel program on a smart TV provided by an embodiment of the present application.

Please refer to FIG. 9, on the basis of the above embodiment, the apparatus provided by the embodiment of the present application further includes:

An extraction module 41, configured to extract link addresses of the associated programs found out in the server before putting the information of the associated programs found out in the same list.

A list module 42, configured to put the information and the link addresses of the associated programs found out in the same list after a corresponding relation therebetween is established.

Wherein, the list module 4 is specifically configured to:

search from the server for the associated programs of the on-demand programs, extract the link addresses of the associated programs found out in the server, put the information and the link addresses of the associated programs found out in the same list after a corresponding relation therebetween is established to form the on-demand program list, and display the on-demand program list in the interface of the on-demand channel.

The link addresses herein can be displayed in the form of images plus characters or video skims or in the form of character descriptions plus link addresses, which is not limited in the embodiment of the present application.

Here, the link addresses of the associated programs found out can be directly extracted from the server after the associated programs are found out; or, after the program main name and the program serial numbers of the associated programs are determined, addresses for saving the various associated programs in the server are searched as the link addresses of the various associated programs.

By employing the technical solution provided by the embodiment of the present application, after the channel is switched from a carousel channel to the on-demand channel, the client may acquire, from the server, the associated programs of the on-demand programs corresponding to the program selected by the selection operation; the various associated programs are assigned to the same on-demand program list and the on-demand program list is displayed in the playing image of the on-demand channel, wherein the on-demand program list includes information of programs associated with the program selected by the selection operation, and the information may include the program serial numbers and the link addresses of the programs. In this way, when the user selects any program in the program list, the television may switch, in response to the selection operation of the user, from the carousel channel which can be watched only in a passive manner to the on-demand channel that allows active selection. Moreover, the on-demand program list corresponding to the program selected by the user is displayed in the on-demand channel, and in this case, the user may watch the programs in the on-demand program list, so that effects of catching up programs played before and skipping to programs about to play later, and increasing flexibility for program watching are achieved, and user experience is improved.

### Embodiment 10

FIG. 10 is a structural schematic diagram of a still further apparatus for selecting a carousel program on a smart TV provided by an embodiment of the present application.

Please refer to FIG. 10, on the basis of embodiment 9, the apparatus provided by the embodiment of the present application may further include:

A taking module 5, configured to take, in response to an address selection operation to a link address in the on-demand program list, video data of a program corresponding to the link address selected by the address selection operation from the server, and play the video data in the on-demand channel.

It needs to be noted that: if the on-demand program list further includes the link addresses of the associated programs, and when the user is more interested in one program among the associated programs in the on-demand program list, the user can click the link address of the program, and in this case, the smart TV may start to play an associated program corresponding to the link address clicked by the user in response to the address selection operation of the user to the link address of the associated program. In this way, when the user clicks a program in the on-demand program list, namely sending a playing instruction, the client may start to play the associated program selected by the user in response to the playing instruction of the user.

In the embodiment of the present application, the user may not only see the on-demand program list of the selected program in the interface of the on-demand channel, but also directly choose an interested program in the on-demand program list and click the link address corresponding to the program; in this way, the process and time of the user manually searching for a playing address of a recommended associated program according to the information of the associated programs can be omitted, the program watching efficiency of the user is improved and the program watching experience is enhanced.

An embodiment of the present application further provides a computer-readable recording medium on which a program for executing the method embodiments is recorded.

Wherein, the computer-readable recording medium includes any mechanism for storing or transmitting information in a computer-(i.e., a computer) readable form. For example, a machine-readable medium includes a read-only memory (ROM), a random access memory (RAM), a magnetic disk storage medium, an optical storage medium, a flash storage memory, propagated signals in electrical, optical, acoustical or other form (i.e., carriers, infrared signals, digital signals, etc.), and the like. It needs to be noted that: each embodiment in the description is described in a progressive manner, and in each embodiment, the differences between the embodiment and other embodiments are mainly explained; the same and similar parts of the various embodiments refer to each other. Apparatus embodiments are just simply described because they are substantially similar to the method embodiments, and correlations therebetween just refer to one part of descriptions of the method embodiments.

Finally, it further needs to be noted that: relation terms such as first and second are merely used for differentiating one entity or operation from another entity or operation rather than certainly requiring or implicating any real relationship or order between the entities or operations. In addition, the terms ‘including’ and ‘containing’ or any other variants thereof are intended to cover non-exclusive containing, such that a process, a method, an article or an apparatus including a series of elements includes not only the elements, but also other elements not specifically listed, or further includes inherent elements of the process, the method, the article or the apparatus. Without more limitations, elements defined by the sentence ‘including a’ shall not be exclusive of additional same elements further existing in the process, the method, the article or the apparatus.

The method and apparatus for selecting the carousel program on the smart TV provided by the embodiments of the present application are described in detail above. In this text, specific examples are utilized to explain the principles and the embodiments of the present application, and the foregoing descriptions of the embodiments are merely used for helping to understand the method of the present application and the main ideas thereof; meanwhile, for those ordinary skilled in the art, alterations will be made to the specific embodiments and the application range according to the ideas of the present application; in conclusion, the content of the description should not be understood as limitations to the present application.

1. A method for selecting a carousel program on a smart TV, comprising:
acquiring a program list of a current carousel channel from a server, and displaying the program list of the current carousel channel in a playing image of the current carousel channel, wherein a program list of each carousel channel is saved in the server;
switching a channel from the current carousel channel to an on-demand channel in response to a selection operation to a program in the program list of the current carousel channel; and
acquiring, from the server, on-demand programs of the program selected by the selection operation, and displaying information of the on-demand programs in an interface of the on-demand channel.

2. The method for selecting the carousel program of claim 1, wherein the operation of acquiring, from the server, the on-demand programs of the program selected by the selection operation comprises:
determining a name of the program selected by the selection operation and taking the same as a target program name; and
searching from the server for programs having the target program name as the on-demand programs of the program selected by the selection operation.

3. The method for selecting the carousel program of claim 1, further comprising:
searching from the server for associated programs of the on-demand programs, putting information of the associated programs found out in the same list to form an on-demand program list, and displaying the on-demand program list in an interface of the on-demand channel.

4. The method for selecting the carousel program of claim 3, further comprising:
extracting link addresses of the associated programs found out in the server before putting the information of the associated programs found out in the same list,
wherein the operation of putting the information of the associated programs found out in the same list specifically is:
putting the information and the link addresses of the associated programs found out in the same list after a corresponding relation therebetween is established.

5. The method for selecting the carousel program of claim 4, further comprising:
taking, in response to an address selection operation to a link address in the on-demand program list, video data of a program corresponding to the link address selected by the address selection operation from the server, and playing the video data in the on-demand channel.

6. An apparatus for selecting a carousel program on a smart TV, comprising:
a carousel module configured to acquire a program list of a current carousel channel from a server, and display the program list of the current carousel channel in a playing image of the current carousel channel, wherein a program list of each carousel channel is saved in the server;
a switching module configured to switch, in response to a selection operation to a program in the program list of the current carousel channel, a channel from the current carousel channel to an on-demand channel; and
a selection module configured to acquire, from the server, on-demand programs of the program selected by the selection operation, and display information of the on-demand programs in an interface of the on-demand channel.

7. The apparatus for selecting the carousel program of claim 6, wherein the selection module comprises:
a determination module configured to determine a name of the program selected by the selection operation and take the same as a target program name; and
a searching module configured to search from the server for programs having the target program name as the on-demand programs of the program selected by the selection operation.

8. The apparatus for selecting the carousel program of claim 6, further comprising:
a list module configured to search from the server for associated programs of the on-demand programs, put information of the associated programs found out in the same list to form an on-demand program list, and display the on-demand program list in the interface of the on-demand channel.

9. The apparatus for selecting the carousel program of claim 8, wherein the list module further comprises:
an extraction module configured to extract link addresses of the associated programs found out in the server before putting the information of the associated programs found out in the same list,
a list module configured to put the information and the link addresses of the associated programs found out in the same list after a corresponding relation therebetween is established;
then, the list module is specifically configured to
search from the server for the associated programs of the on-demand programs, extract the link addresses of the associated programs found out in the server, put the information and the link addresses of the associated programs found out in the same list after a corresponding relation therebetween is established to form the on-demand program list, and display the on-demand program list in the interface of the on-demand channel.

10. The apparatus for selecting the carousel program of claim 9, further comprising:
a taking module configured to take, in response to an address selection operation to a link address in the on-demand program list, video data of a program corresponding to the link address selected by the address selection operation from the server, and play the video data in the on-demand channel.

11. A computer-readable recording medium on which a program for executing the method of claim 1 is recorded.

12. A computer-readable recording medium on which a program for executing the method of claim 2 is recorded.

13. A computer-readable recording medium on which a program for executing the method of claim 3 is recorded.

14. A computer-readable recording medium on which a program for executing the method of claim 4 is recorded.

15. A computer-readable recording medium on which a program for executing the method of claim 5 is recorded.
